(19) United States
(12) Patent Application Publication
(10) Pub. No.: US 2013/0030855 A1
(43) Pub. Date: Jan. 31, 2013

(54) Collective Tracking of Availability Information

(71) Applicant: Roy Schoenberg, Boston, MA (US)

(72) Inventor: Roy Schoenberg, Boston, MA (US)

(21) Appl. No.: 13/190,898

(22) Filed: Jul. 26, 2011

(51) Int. Cl. G06Q 10/00

(52) U.S. Cl. 705/7.15

(57) ABSTRACT

A computer-implemented method includes receiving, by one or more computers, a request for aggregation of availability status information for provider practices; retrieving, by the one or more computers, the availability status information for service providers for which the request was received; collectively tracking the retrieved availability status information; and generating, by the one or more computers, a graphical user interface that when rendered on a display device renders: a visual representation of the collectively tracked availability status information arranged by provider practice.

### BACKGROUND

Systems have been developed to connect consumers and their providers over the Internet and the World Wide Web. Some systems use e-mail messaging and web-based forms to increase the level of connectivity between a member of a health plan and an assigned health care provider. The consumer sends an e-mail or goes to a website that generates and sends a message (typically an e-mail or an e-mail type message) to a local provider.

These types of services have been broadly referred to as “e-visits.” While generally viewed as an addition to the spectrum of services that may be desired by consumers, the benefits of such services are not clear. One of the concerns associated with offering additional communication channels, such as e-mail, is that it can result in over consumption of services, rather than provide for better coordination.

Another system is a brokerage type of system as described in U.S. Pat. No. 7,590,550, which is incorporated herein by reference.

### SUMMARY

In one aspect of the present disclosure, a computer-implemented method includes a request for aggregation of availability status information for provider practices; retrieving, by the one or more computers, the availability status information for service providers for which the request was received; collectively tracking the retrieved availability status information; and generating, by the one or more computers, a graphical user interface that when rendered on a display device renders: a visual representation of the collectively tracked availability status information arranged by provider practice.

Implementations of the disclosure may include one or more of the following features. In some implementations, the method includes receiving the availability status information and provider practice information, with an item of provider practice information specifying an identity of a provider practice sending an item of availability status information. In other implementations, the method includes tagging the availability status information with the provider practice information, with an item of availability status information being tagged in accordance with an identity of a provider practice sending the item of availability status information. In still other implementations, the graphical user interface is accessible in a virtual location.

In some implementations, the method includes identifying, at least partly based on the virtual location of the requested graphical user interface, provider practices for which collectively tracked availability status information is requested. In other implementations, the visual representation is a first visual representation, and wherein the graphical user interface further renders: one or more second visual representations of information identifying the service providers, with the one or more second visual representations juxtaposed to one or more availability status indicators for the service providers.

In another aspect of the disclosure, a computer program product is tangibly stored on a computer readable storage media, the computer program product includes instructions for causing a processor to: receive a request for aggregation of availability status information for provider practices; retrieve the availability status information for service providers for which the request was received; collectively track the retrieved availability status information; and generate a graphical user interface that when rendered on a display device renders: a visual representation of the collectively tracked availability status information arranged by provider practice. Implementations of this aspect of the present disclosure may include one or more of the foregoing features.

In still another aspect of the disclosure, an electronic system includes a processor and a computer program product tangibly stored on a computer readable storage media, the computer program product includes instructions for causing the processor to: receive a request for aggregation of availability status information for provider practices; retrieve the availability status information for service providers for which the request was received; collectively track the retrieved availability status information; and generate a graphical user interface that when rendered on a display device renders: a visual representation of the collectively tracked availability status information arranged by provider practice. Implementations of this aspect of the present disclosure may include one or more of the foregoing features.

### DESCRIPTION OF DRAWINGS

FIG. 1 is a diagrammatic view of a system for aggregating availability status information.

FIG. 2 is a flow chart of a process for aggregating availability status information.

FIG. 3 is a flow chart of a process for generating visual representations of aggregated availability status information.

FIG. 4 is a graphical user interface that when rendered on a display device renders a visual representation of aggregated availability status information.

FIG. 5 is a block diagram of a computer (computer system) showing exemplary components that can be used for the brokerage system and/or client systems.

### DETAILED DESCRIPTION

Described below are techniques for aggregating (e.g., collectively tracking) availability status information received from numerous brokerage services running on numerous, different brokerage systems. As described in U.S. Pat. No. 7,590,550, a brokerage system implements a brokerage service to track real-time availability status information (e.g., information indicative of availability of service providers) and to broker interactions between available service providers and consumers of services. For example, a provider practice (e.g., a doctor's office) installs the brokerage service on a server used by the provider practice to implement a brokerage system for the provider practice. The provider practice's brokerage system tracks availability of the service providers associated with the provider practice (e.g., availability of physicians associated with a doctor's office).

The system collects the availability status information from the numerous, different provider practices running the brokerage service. Using the collected availability status information, the system determines which service providers from which provider practices are available for real-time consultations with consumers, for example, by aggregating together the collected availability status information. The system generates a resource from which the aggregated availability status information is accessed and viewed by a consumer. The resource includes, for example, a web page, a document, a graphical user interface, and so forth. For example, the system generates a web page that displays a visual representation of the aggregated availability status information and is accessible to a consumer from a uniform resource location (“URL”).

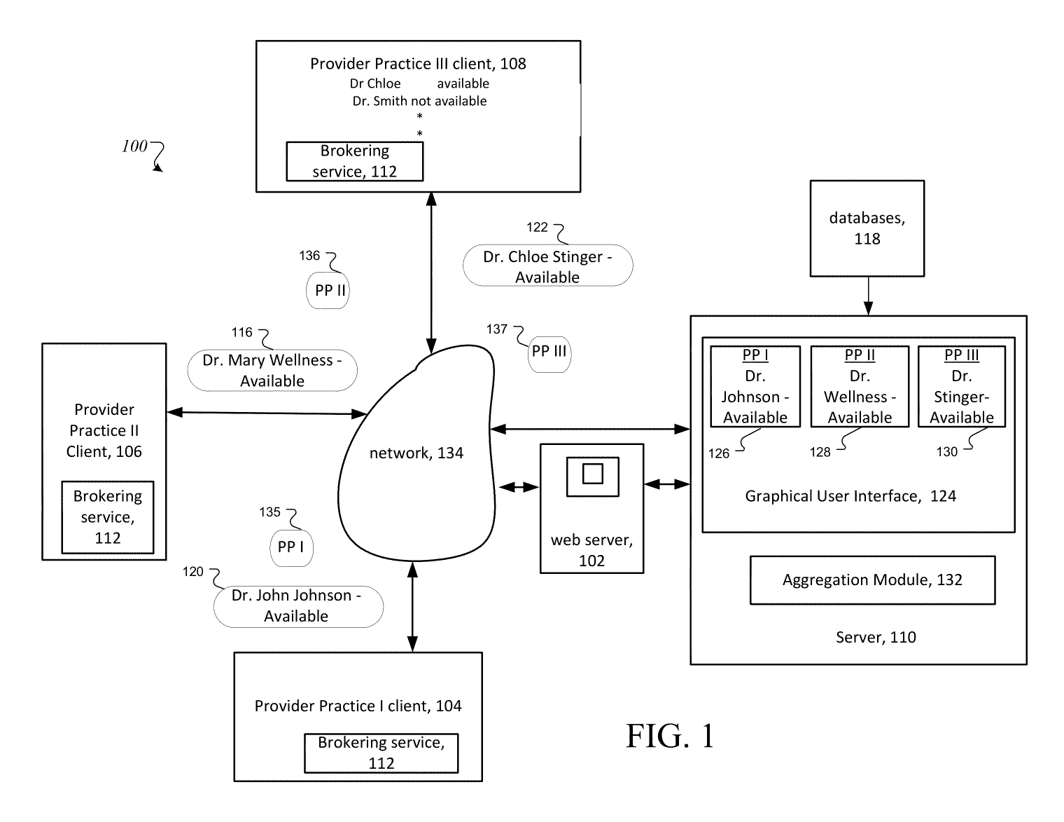

FIG. 1 shows an example system 100 for aggregating availability status information. System 100 includes a computerized system or server 110 and client devices 104, 106, 108. Client devices 104, 106, 108 include any combination of mobile devices, PDAs, cellular phones, portable or desktop computer systems, and so forth. Client devices 104, 106, 108 are used by various provider practices (“PP”) and are configured to run brokering service 112 to track availability of service providers associated with the practice. Client devices 104, 106 and 108 are used by corresponding provider practices (“provider practice I”), and (“provider practice II”) (“provider practice III”).

Using brokerage service 112, client devices 104, 106, 108 generate availability status information 116, 120, 122 for the respective provider practices. For example, through execution of brokerage service 112, client device 104 generates availability status information 120 specifying that a service provider, “Dr. John Johnson” is available for a real-time consultation with a consumer. Dr. John Johnson is a service provider associated with provider practice I. Client device 104 sends availability status information 120 to server 110, e.g., via a message that includes availability status information 120.

Additionally, through execution of brokerage service 112, client device 106 generates availability status information 116 specifying that another service provider “Dr. Mary Wellness” is available for a real-time consultation with a consumer. Dr. Mary Wellness is a service provider associated with provider practice II. Through execution of brokerage service 112, client device 108 generates availability status information 122 specifying that service provider “Dr. Chloe Stinger” is available for a real-time consultation with a consumer. Dr. Chloe Stinger is a service provider associated with provider practice III.

Client devices 104, 106, 108 send availability status information 116, 120, 122 to server 110 over a network 134, e.g., the Internet or other types of networks. Server 110 saves availability status information 116, 120, 122 in database 118. Client devices 104, 106, 108 also send provider practice information 135, 136, 137 (e.g., PP I, PP II, PP III) to server 110. Provider practice information 135, 136, 137 specifies a name (or other identifying information) of the provider practice sending availability status information 116, 120, 122.

Server 110 receives availability status information 116, 120, 122 and provider practice information 135, 136, 137, and tags availability status information 116, 120, 122 with the provider practice information 135, 136, 137. Server 110 uses the tags to query database 118 for availability status information associated with particular provider practices (e.g., provider practices matching a requested list of provider practices).

For example, server 110 tags availability status information 120 with information 135 specifying that availability status information 120 is associated with the first provider practice (“PP I”). Server 110 tags availability status information 116 with information 136 specifying that availability status information 116 is associated with the second provider practice (“PP II”). Server 110 tags availability status information 122 with information 137 specifying that availability status information 122 is associated with the third provider practice (“PP III”).

Server 110 also includes one or more processes such as aggregation module 132. Aggregation module 132 queries database 118 for availability status information, for example, associated with certain provider practices. Aggregation module 132 sends to database 118 a query for availability status information associated with certain provider practices. Database 118 retrieves availability status information that is tagged with provider practice information corresponding to the requested provider practices. Database 118 sends this determined availability status information and tags to aggregation module 132.

Using availability status information 116, 120, 122 and tags associated with PP I 135, PP II 136, and PPP III 137, aggregation module 132 generates graphical user interface 124. The graphical user interface 124 renders on a display device visual representations 126, 128, 130 of availability status information 116, 120, 122 associated with PP I 135, PP II 136, and PPP III 137. These visual representations 126, 128, 130 are also be referred to herein as “silos” of availability status information 116, 120, 122 for particular provider practices.

Server 110 operates as a service running on web server 102. Using web server 102, a client device used by a consumer accesses graphical user interface 124, for example, by accessing a URL for graphical user interface 124.

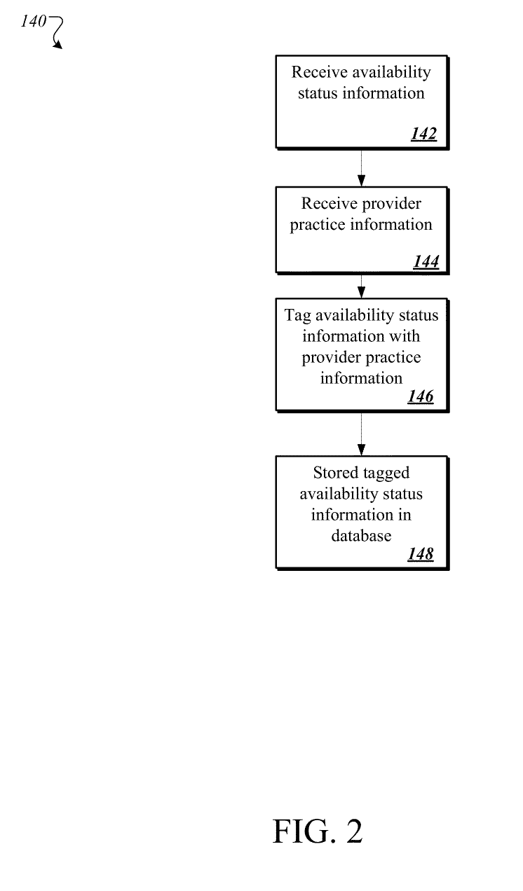

FIG. 2 depicts a process 140 for aggregating availability status information 116, 120, 122. In operation, server 110 receives (142) availability status information 116, 120, 122, e.g., from client devices 116, 120, 122. Server 110 also receives (144) from client devices 116, 120, 122 provider practice information 135, 136, 137. Aggregation module 132 tags (146) availability status information 116, 120, 122 with provider practice information 135, 136, 137. For example, availability status information 120 is tagged with provider practice information 135 for PP I. Availability status information 116 is tagged with provider practice information 136 for PP II. Availability status information 122 is tagged with provider practice information 137 for PP III. Server 110 stores (148) in database 118 the tagged availability status information.

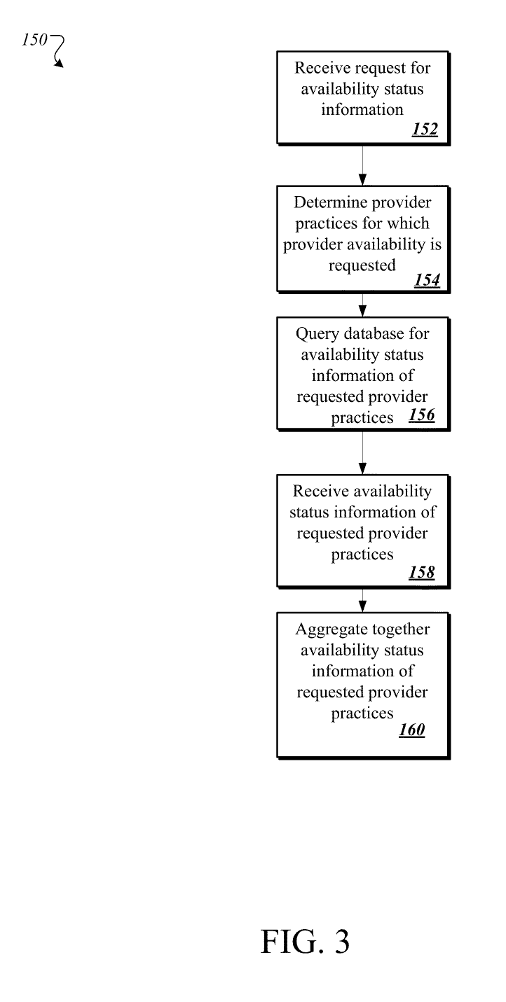

FIG. 3 depicts a process 150 for generating visual representations 126, 128, 130 of aggregated availability status information. In operation, server 110 receives (152) a request (not shown) for availability status information, e.g., to be displayed in graphical user interface 124. For example, a consumer may request graphical user interface 124 by using a web browser to access a URL for graphical user interface 124.

Server 110 generates numerous, different graphical user interfaces to display provider availability for different provider practices and/or subscribers of availability status information. Generally, a subscriber is an entity that receives aggregated availability status information for a fee.

For example, a subscriber is an insurance company. Two different insurance companies subscribe to the aggregated availability status information, namely insurance company A and insurance company B. Insurance company A provides its consumers with access to PP I, PP II, PP III. Aggregation module 132 generates a listing of the provider practices for insurance company A. Insurance company B provides its consumers with access to PP II, PP III. Aggregation module 132 also generates a listing of the provider practices for insurance company B.

For insurance company A, aggregation module 132 generates a graphical user interface (e.g., graphical user interface 124) that displays silos for PP I, PP II, PP III. Graphical user interface 124 for insurance company A is associated with a unique URL, e.g., “http://insuranceA/availability.” For insurance company B, aggregation module 132 generates another, different graphical user interface displaying silos for PP II, PP III. The graphical user interface for insurance company B is also associated with a unique URL, e.g., “http://insuranceB/availability.”

Still referring to FIG. 3, server 110 determines (154) the provider practices for which availability status information is requested. The consumer requests the availability status information for provider practices of insurance company A by requesting graphical user interface 124, which is associated with insurance company A. The request received by server 110 includes the URL for graphical user interface 124. Using the contents of the URL, server 110 identifies that the request is for provider practices of insurance company A. Server 110 retrieves from database 118 the listing of provider practices for insurance company A, namely, PP I, PP II and PP III.

Aggregation module 132 queries (156) database 118 for availability status information 116, 120, 122 associated with the requested provider practices by requesting availability status information 116, 120, 122 that is tagged with provider practice information 135, 136, 137. Aggregation module 132 receives (158) availability status information 116, 120, 122. Aggregation module 132 also receives (not shown) provider practice information 135, 136, 137. Using retrieved availability status information 116, 120, 122 and provider practice information 135, 136, 137, aggregation module 132 aggregates (160) availability status information 116, 120, 122, e.g., by generating graphical user interface 124 with silos 126, 128, 130.

In a variation of FIG. 3, server 110 sends client devices 104, 106, 108 requests for availability status information 116, 120, 122, e.g., following receipt of a request for graphical user interface 124. Aggregation module 132 receives availability status information 116, 120, 122 and updates silos 126, 128, 130 with availability status information 116, 120, 122. In still another variation, server 110 sends client devices 104, 106, 108 requests for availability status information 116, 120, 122, e.g., at pre-defined intervals.

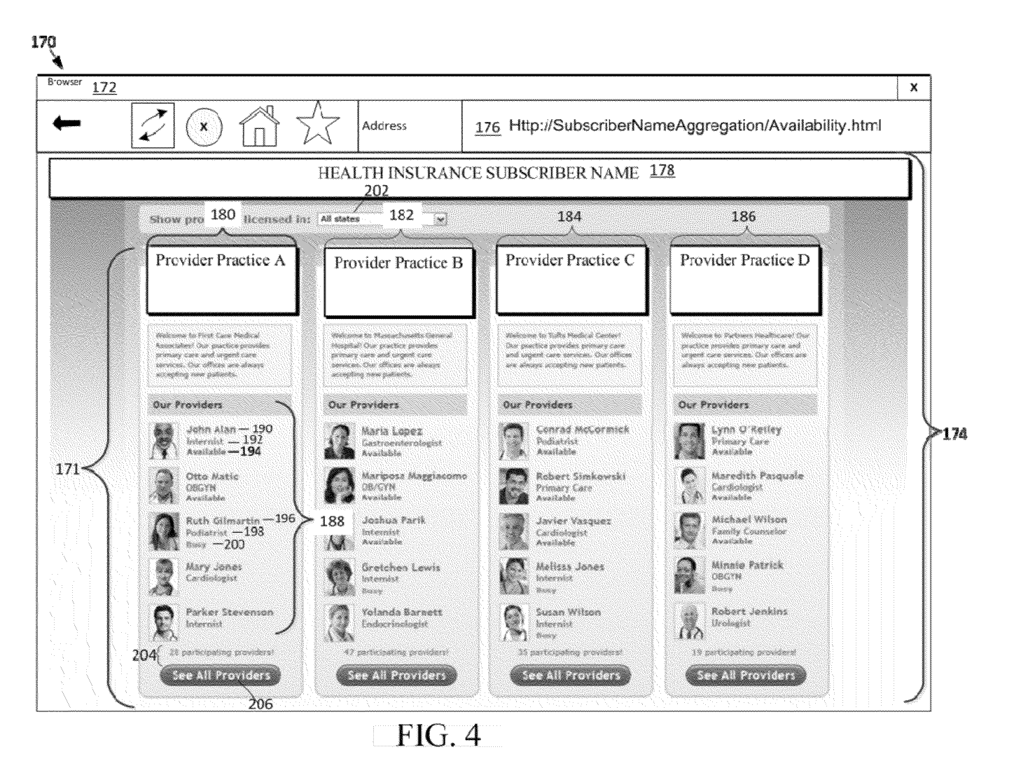

FIG. 4 is a screenshot 170 of graphical user interface 174 that when rendered on a display device (e.g., via web browser 172) renders visual representation 171 of aggregated availability status information. Web browser 172 includes portion 176 that displays the virtual location (e.g., URL of http://subscribernameaggregation/availability.html) of graphical user interface 174. Graphical user interface 174 also includes portion 178 that displays information indicative of a name of a subscriber to the aggregated availability status information provided by server 110. The subscriber name may be the name of a corporation, an insurance company, an educational institute, and so forth. Graphical user interface 174 includes silos 180, 182, 184, 186.

Silos 180, 182, 184, 186 provide availability status information for numerous, different provider practices. Silo 180 provides availability status information from provider practice A. Silo 182 provides availability status information for provider practice B. Silo 184 provides availability status information for provider practice C. Silo 186 provides availability status information for provider practice D. Aggregated availability status information includes the availability status information in silos 180, 182, 184, 186.

Silo 180 includes portion 188. Portion 188 provides a listing of service providers associated with provider practice A and availability status indicators for the service providers. An availability status indicator is information specifying an availability status of a service provider, including, for example, whether a service provider is available, busy, engaged with another consumer, and so forth. Portion 188 includes provider information 190. Provider information 190 includes information specifying the name of a service provider. Portion 188 also includes service provider type information 192. Service provider type information 192 includes information specifying a type of service provider, for example, an internist, a gynecologist, a podiatrist, a cardiologist, a gastroenterologist, and so forth. Portion 188 also includes availability status indicator 194. Availability status indicator 194 indicates that the service provider associated with service provider information 190 is presently available for consultations with consumers.

Portion 188 of silo 180 also includes service provider information 196. Service provider information 196 includes identifying information for another service provider associated with provider practice A. Portion 188 also includes service provider type information 198. Service provider type information 198 includes information specifying the type of service provider that is associated with service provider information 196.

Portion 188 of silo 180 also includes availability status indicator 200. Available status indicator 200 displays information indicative of the availability status for the service provider associated with service provider information 196. Portion 188 of silo 180 also includes section 204. Section 204 displays information indicative of a number of service providers that are associated with provider practice A.

Silo 180 also includes button 206. Upon selection of button 206, for example, by a consumer viewing graphical user interface 174, server 110 is configured to display for the consumer a complete listing of all the service providers that are associated with provider practice A. Silos 182, 184, 186 include the same and/or similar types of information as silo 180.

Graphical user interface 174 also includes portion 202. Portion 202 may include a text box and/or other selectable area through which a consumer can specify certain criterion in which to view provider practices. For example, a consumer can use portion 202 to view provider practices associated with a particular subscriber in certain states, for example, Maryland and Massachusetts, or to view provider processes for all states.

Although the examples described herein primarily refer to medical service providers and medical provider processes, it is understood by one of ordinary skill in the art that the techniques described herein are generally applicable to other types of provider practices including, for example, financial services provider practices, entertainment services provider practices, and so forth.

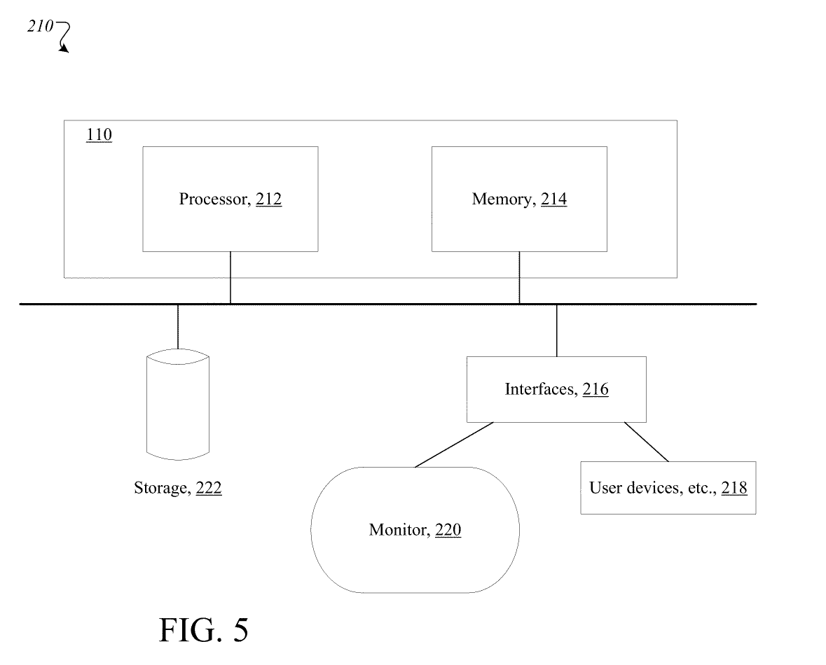

FIG. 5 is a block diagram of components 210 of the engagement brokerage system. User devices 218 can be any sort of computing device capable of taking input from a user and communicating over a network (not shown) with server 110 and/or with other client devices. For example, user device 218 can be a mobile device, a desktop computer, a laptop, a cell phone, a personal digital assistant (“PDA”), a server, an embedded computing system, a mobile device and so forth. User devices 218 include monitor 220, which renders visual representations of interface 216.

Server 110 can be any of a variety of computing devices capable of receiving information, such as a server, a distributed computing system, a desktop computer, a laptop, a cell phone, a rack-mounted server, and so forth. Server 110 may be a single server or a group of servers that are at a same location or at different locations.

Server 110 can receive information from user device 218 via interfaces 216, including, e.g., graphical user interfaces. Interfaces 216 can be any type of interface capable of receiving information over a network, such as an Ethernet interface, a wireless networking interface, a fiber-optic networking interface, a modem, and so forth. Server 110 also includes a processor 212 and memory 214. A bus system (not shown), including, for example, a data bus and a motherboard, can be used to establish and to control data communication between the components of server 110.

Processor 212 may include one or more microprocessors. Generally, processor 212 may include any appropriate processor and/or logic that is capable of receiving and storing data, and of communicating over a network (not shown). Memory 214 can include a hard drive and a random access memory storage device, such as a dynamic random access memory, machine-readable media, or other types of non-transitory machine-readable storage devices.

Components 210 also include storage device 222, which is configured to store information collected through the brokerage system during a service provider's consultation with a consumer. In another example, storage device 222 is also configured to receive information (e.g., a number of patient's waiting in a physical waiting room) from a physician's physical office and to integrate and to integrate the information associated with the physical office into the brokerage system so that the brokerage system may access and may use the information associated with the physical office space.

Embodiments can be implemented in digital electronic circuitry, or in computer hardware, firmware, software, or in combinations thereof. Apparatus of the invention can be implemented in a computer program product tangibly embodied or stored in a machine-readable storage device and/or machine readable media for execution by a programmable processor; and method actions can be performed by a programmable processor executing a program of instructions to perform functions and operations of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the description claims. For example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. A computer-implemented method comprising:
receiving, by one or more computers, a request for aggregation of availability status information for provider practices;
retrieving, by the one or more computers, the availability status information for service providers for which the request was received;
collectively tracking the retrieved availability status information; and
generating, by the one or more computers, a graphical user interface that when rendered on a display device renders:
a visual representation of the collectively tracked availability status information arranged by provider practice.

2. The computer-implemented method of claim 1, further comprising:
receiving the availability status information and provider practice information, with an item of provider practice information specifying an identity of a provider practice sending an item of availability status information.

3. The computer-implemented method of claim 2, further comprising:
tagging the availability status information with the provider practice information, with an item of availability status information being tagged in accordance with an identity of a provider practice sending the item of availability status information.

4. The computer-implemented method of claim 1, wherein the graphical user interface is accessible in a virtual location.

5. The computer-implemented method of claim 4, further comprising:
identifying, at least partly based on the virtual location of the requested graphical user interface, provider practices for which collectively tracked availability status information is requested.

6. The computer-implemented method of claim 1, wherein the visual representation is a first visual representation, and wherein the graphical user interface further renders:
one or more second visual representations of information identifying the service providers, with the one or more second visual representations juxtaposed to one or more availability status indicators for the service providers.

7. A computer program product tangibly stored on a computer readable storage media, the computer program product comprising instructions for causing a processor to:
receive a request for aggregation of availability status information for provider practices;
retrieve the availability status information for service providers for which the request was received;
collectively track the retrieved availability status information; and
generate a graphical user interface that when rendered on a display device renders:
a visual representation of the collectively tracked availability status information arranged by provider practice.

8. The computer program product of claim 7 further comprising instructions for causing the processor to:
receive the availability status information and provider practice information, with an item of provider practice information specifying an identity of a provider practice sending an item of availability status information.

9. The computer program product of claim 8 further comprising instructions for causing the processor to:
tag the availability status information with the provider practice information, with an item of availability status information being tagged in accordance with an identity of a provider practice sending the item of availability status information.

10. The computer program product of claim 7, wherein the graphical user interface is accessible in a virtual location.

11. The computer program product of claim 10 further comprising instructions for causing the processor to:
identify, at least partly based on the virtual location of the requested graphical user interface, provider practices for which collectively tracked availability status information is requested.

12. The computer program product of claim 7, wherein the visual representation is a first visual representation, and wherein the graphical user interface further renders:
one or more second visual representations of information identifying the service providers, with the one or more second visual representations juxtaposed to one or more availability status indicators for the service providers.

13. An electronic system comprising:
a processor; and
a computer program product tangibly stored on a computer readable storage media, the computer program product comprising instructions for causing the processor to:
receive a request for aggregation of availability status information for provider practices;
retrieve the availability status information for service providers for which the request was received;
collectively track the retrieved availability status information; and
generate a graphical user interface that when rendered on a display device renders:
a visual representation of the collectively tracked availability status information arranged by provider practice.

14. The electronic system of claim 13 further comprising instructions for causing the processor to:
receive the availability status information and provider practice information, with an item of provider practice information specifying an identity of a provider practice sending an item of availability status information.

15. The electronic system of claim 14 further comprising instructions for causing the processor to:
tag the availability status information with the provider practice information, with an item of availability status information being tagged in accordance with an identity of a provider practice sending the item of availability status information.

16. The electronic system of claim 13, wherein the graphical user interface is accessible in a virtual location.

17. The electronic system of claim 16 further comprising instructions for causing the processor to:
identify, at least partly based on the virtual location of the requested graphical user interface, provider practices for which collectively tracked availability status information is requested.

18. The electronic system of claim 13, wherein the visual representation is a first visual representation, and wherein the graphical user interface further renders:
one or more second visual representations of information identifying the service providers, with the one or more second visual representations juxtaposed to one or more availability status indicators for the service providers.
